(19) United States
(12) Patent Application Publication
(10) Pub. No.: US 2007/0107467 A1
(43) Pub. Date: May 17, 2007

(54) Metal glass body, process for producing the same and apparatus therefor

(75) Inventors: Kenji Miwa, Aichi (JP); Takuya Tamura, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Inst of Industrial Science and Tech., Tokyo (JP)

(21) Appl. No.: 10/573,585

(22) PCT Filed: Sep. 27, 2004
(86) PCT No.: PCT/JP04/14070

§ 371 Date: Mar. 27, 2006

(30) Foreign Application Priority Data
Sep. 25, 2003 (JP) 2003-334378

(51) Int. Cl. C03C 15/00

(52) U.S. Cl. 65/30.13; 65/374.12

(57) ABSTRACT

The present invention relates to a metal glass body and to a manufacturing method and apparatus therefor, and the present invention relates to a metal glass body having a specific metal glass texture structure of fine crystals uniformly dispersed throughout a glass phase, to a metal glass body manufacturing method wherein the metal glass body is manufactured by solidifying a molten metal while applying electromagnetic vibrating force thereto to form a metal glass, during which a direct current magnetic field and an alternating current electrical field are applied simultaneously to generate electromagnetic vibration which is exerted on the molten metal, and to an apparatus for manufacturing a metal glass body. According to the present invention, it is possible to provide a method for manufacturing a novel metal glass body which allows mass production of metal glass members which hold promise as lightweight, highly-strong and highly-functional structural members, along with a metal glass body with a novel metal glass texture structure obtained by this method.

### TECHNICAL FIELD

The present invention relates to a metal glass body having fine crystals dispersed uniformly throughout the entire sample, and to a method for manufacturing the metal glass body and to an apparatus therefor, and more particularly relates to a method for manufacturing a novel metal glass body whereby a metal glass body having a metal glass texture structure of fine crystals uniformly dispersed throughout a glass phase can be produced by solidifying a molten metal while applying electromagnetic vibrating force thereto, to a novel metal glass body obtained by this method and to the manufacture thereof. In the field of metal glass manufacturing technology, which has conventionally required extremely rapid cooling speeds, the present invention provides a novel technology that allows metal glass, which has great potential as a light, highly-strong and highly-functional structural material, to be mass-produced by a method that is not dependent on cooling speed, and provides a high-quality metal glass body.

### Background Art

In general, it is expected that metal glass will be applied to ultraprecise members and precision machine parts for micromachines and the functional members of such high-precision instruments as Coriolis flow meters, pressure sensors, linear actuators and the like, and it holds great promise as a material with high functional capability as a lightweight, very strong structural material for airplanes, automobiles and the like. Conventionally, it has been necessary to cool an alloy melt rapidly at a cooling speed above a certain threshold in order to manufacture metal glass (Japanese Laid-Open Patent Publication Nos. 2001-62548, 2000-271730). If the alloy melt is not cooled rapidly, the result is metal crystals rather than metal glass. Therefore, if metal glass is to be applied as a practical material to a variety of parts, new technologies need to be developed whereby crystallization does not occur even when rapid cooling is not performed. At present, however, there is no process other than the rapid cooling method. Consequently, current manufacturing methods are aimed at obtaining metal glass at as slow a cooling rate as possible by controlling the alloy elements and amounts thereof to minimize the effect of cooling rate (Japanese Laid-Open Patent Publication Nos. 2000-256812, H11-131199).

However, in manufacturing methods that rely on rapid cooling, extremely high cooling speeds are necessary to obtain metal glass with some alloy systems, and since even with other alloy systems a specific rapid cooling speed is still required, there is a limit on the size of the resulting member, and large sizes cannot be manufactured with certain alloy systems. Thus, in order for metal glass to be applicable to a variety of members, there needs to be a way to manufacture it that is not dependent on rapid cooling and that allows it to be manufactured into a member of a certain size, and in this technical field, there is strong demand for the development of technologies which will allow this.

### DISCLOSURE OF THE INVENTION

Under these circumstances, and in light of the aforementioned background art, the inventors discovered as a result of exhaustive research aimed at developing a new technology which would allow a metal glass to be manufactured by a process that was not dependent on cooling speed that the specific object could be achieved by applying an electromagnetic vibrating force to molten metal, and perfected the present invention after further research. It is an object of the present invention to provide a method of improving metal glass formation capability through the use of electromagnetic vibrating force, and a method of manufacturing a metal glass and an apparatus using that method. Further it is an object of the present invention to provide a novel metal glass body having a specific metal glass texture structure fundamentally different from the texture structure of metal glass produced by conventional rapid solidification. It is also an object of the present invention to manufacture and provide a lightweight, very strong and highly-functional metal glass member and product by means of that method.

To resolve the aforementioned issues, the present invention is a metal glass body prepared by a method that does not depend on cooling speed, the metal glass body having a metal glass texture structure of fine crystals uniformly dispersed throughout a glass phase. In preferred modes of this metal glass body, (1) the fine crystals have a size controlled in the range of nanometers to micrometers, (2) the metal is an alloy system capable of forming glass, (3) the metal glass body is a composite material comprising fine crystals of a specific composition and a metal glass single phase, (4) the composition of the fine crystals is controlled by selecting the alloy composition. The present invention is also a metal glass product comprising the aforementioned metal glass body. In a preferred mode, this metal glass product is a highly-functional product which is a structural member. Moreover, the present invention is a method for manufacturing a metal glass body, whereby either a single-phase metal glass or a metal glass body having a metal glass texture structure of fine crystals dispersed uniformly throughout a glass phase is manufactured by solidifying a molten metal while applying electromagnetic vibrating force thereto. In preferred modes of this method, (1) a direct current magnetic field and an alternating current electrical field are simultaneously applied so as to generate electromagnetic vibration which is exerted on the molten metal, thereby producing the metal glass body, (2) the metal glass body is produced with generation of electromagnetic vibration in a specific current frequency band (100 Hz or more), (3) the metal glass body is produced with generation of electromagnetic vibration at a specific magnetic field strength (1 Tesla or more), (4) metal glass formation capability is improved by increasing the current frequency, (5) meta glass formation capability is improved by applying the electromagnetic vibration at the liquid stage before solidification, (6) the non-vibrating retention time after application of electromagnetic vibration is shortened, (7) metal glass formation capability is improved by increasing the applied current strength of the electromagnetic vibration, (8) the metal is an alloy system capable of forming glass, (9) the alloy composition is selected and the electromagnetic vibrating force conditions and/or temperature conditions are adjusted so as to manufacture a composite material in which the functionality of the metal glass and the properties of strength, toughness and resistance to breakage conferred by the fine crystals are controlled. Moreover, the present invention is an apparatus for manufacturing a metal glass body equipped with a container for storing a sample metal material, means for heating and melting the metal material, means for generating and applying electromagnetic vibration, cooling means for cooling a molten metal and means for measuring and controlling temperature, wherein a metal glass is produced by solidifying the molten metal while applying electromagnetic vibrating force thereto. In a preferred mode of this apparatus, the means for generating electromagnetic vibration is a superconducting magnet.

The present invention is explained in more detail below.

The present invention provides a way of manufacturing a metal glass by solidifying a molten metal while applying electromagnetic vibrating force thereto, and a novel metal glass body with a specific metal glass texture structure prepared by the aforementioned method. The present invention preferably employs metals and alloys are easy to make into metal glass, and the present invention can be applied to all alloy systems capable of forming glass. Examples include magnesium base alloys, iron base alloys and the like, but these examples are not limiting and any kind can be used that is capable of forming metal glass. An example of a magnesium system is Mg₆₅Y₁₀Cn₂₅ (Y: 0-30, Cu: 0-40), and an example of an iron system is (Fe_{0.6}Co_{0.4})₇₂Si₄B₂₀Nb₄. Other specific examples of magnesium systems include Mg—Ca, Mg—Ni, Mg—Cu, Mg—Zn, Mg—Y, Mg—Ca—Al, Mg—Ca—Li, Mg—Ni—La, Mg—Cu—La, Mg—Cu—Y, Mg—Ni—Y, Mg—Cu—Ce, Mg—Cu—Nd, Mg—Zn—Si, Mg—Al—Zn, Mg—Ni—Si, Mg—Cu—Si, Mg—Ni—Si, Mg—Ca—Si, Mg—Ni—Ge, Mg—Cu—Ge, Mg—Zn—Ge and the like, and examples of iron systems include (Fe_{0.8}Co_{0.2})₇₄Si₄B₂₀Nb₂, Fe—Al—P, Fe—Al—C, Fe—Al—B, Fe—Si—B-Nb, Fe—Si—B—Zr, (Fe_{0.775}Si_{0.10}B_{0.125})₉₈Nb₂, (Fe_{0.75}Si_{0.10}B_{0.15})₉₉Zr₁, (Fe_{0.75}Si_{0.10}B_{0.15})₉₆Nb₄, Fe—Co—Ni—P—C—B, Fe—Si—B, Fe—P—C, Fe—Co—Si—B, Fe₇₅Si₁₀B₁₅, Fe₇₂Si₆B₁₈Nb₄, Fe₇₀Si₄B₂₀Nb₆, Fe₆₈Si₄B₂₀Nb₈, Fe₇₀Si₄B₂₀Nb₆ and Fe₆₈Si₄B₂₀Nb₈. Examples of alloy systems other than magnesium and iron systems include La (lanthanum), Zr (zirconium), Pd (palladium), Co (cobalt), Ni (nickel), Ti (titanium), Al (aluminum), Cu (copper), Nd (neodymium), Pr (praseodymium) and Pt (platinum) systems. Electromagnetic vibrating force generated by simultaneous application of a direct current magnetic field and an alternating current electrical field can be used as the electromagnetic vibrating force in the present invention, but this is not a limitation and another with similar effects could be used in the same way. A principal feature of the present invention is that a molten metal is solidified with application of electromagnetic vibrating force generated by a combination of a direct current magnetic field and an alternating current electrical field so as to allow a metal glass to be manufactured by a method that is not dependent on cooling speed.

With the present invention, it is also possible to improve metal glass formation capability by increasing the current frequency. Also, the metal glass can be formed and manufactured more easily in the present invention, if the electromagnetic vibration is applied at the liquid stage before solidification, and if the electromagnetic vibration rest time is short, or in other words, if the non-vibrating storage time after application of electromagnetic vibration at the liquid stage is short. Moreover, it is possible to improve metal glass formation capability by increasing the applied current strength of the electromagnetic vibration so as to increase the electromagnetic vibrating force. The texture structures of a metal glass produced by conventional rapid solidification consists of a single glass phase, making it fundamentally different from the texture structure of a metal glass body prepared by the method of the present invention, which has a structure of fine crystals dispersed uniformly throughout a glass phase, and a metal glass body of the present invention can be clearly distinguished from a conventional metal glass by examining these metal glass texture structures. Thus, a metal glass body produced by the method of the present invention has a specific metal glass texture structure not seen with metal glass produced by conventional methods.

In the present invention, a metal glass body can be formed by fixing a sample metal material in a holding container and heating and melting it with an external heater for example, and then applying electromagnetic vibration for a fixed time by means of a superconducting magnet or the like, while at the same time solidifying it by cooling with cooling means. In this case, examples of the electromagnetic vibrating force include a magnetic field of 2 to 10 T, an electromagnetic vibrating current of 3 to 10 A and an electromagnetic vibrating frequency of 100-5000 Hz, but these values can be set as desired to the optimum conditions for the type of metal material and the like.

In conventional methods using rapid solidification, if the sample is too large differences in cooling speed occur between the surface and the inside of the sample, so that the fine crystals cannot be dispersed uniformly throughout the entire sample, but in this process because the metal glass is produced with generation of electromagnetic vibration, the cooling speed is the same on the surface and within the sample due to the electromagnetic vibration, allowing the fine crystals to be dispersed uniformly throughout the entire sample. That is, in the present invention the electromagnetic vibrating force can be applied individually to the metal atoms in a liquid state which make up the metal glass body, thus preventing the atoms from changing their alignment as they change from a liquid state to a solid state, and allowing a change to a solid state while retaining the alignment of the liquid state. In this way, it is possible to obtain a metal glass body having a metal glass texture structure of fine crystals uniformly dispersed throughout a glass phase.

Moreover, in the present invention the size of the fine crystals can be controlled on the order of nanometers to micrometers because the metal glass formation capability is controlled by means of the electromagnetic vibration conditions (current frequency, electromagnetic vibrating force, etc.), so that the aforementioned metal glass body can be manufactured and provided with fine crystals having a size controlled within the range of nanometers to micrometers. Moreover, in the metal glass body of the present invention, the fine crystals can be dispersed as fine crystals of any composition depending on what alloy composition is selected. A metal glass having uniformly dispersed fine crystals of a specific composition can be used more favorably as a high-strength composite material than can a metal glass single substance. Examples of the apparatus for manufacturing the metal glass body of the present invention are a metal glass manufacturing apparatus having a container for storing the sample metal material, means for heating and melting the metal material, means for generating and applying electromagnetic vibration, cooling means for cooling the molten metal and means for measuring and controlling temperature as essential elements and the aforementioned apparatus wherein the means for generating electromagnetic vibration is a superconducting magnet, but these examples are not limiting, and the specific structures of the aforementioned means can be designed at will in the present invention.

In the present invention, a metal glass is manufactured by a method that is not dependent on cooling speed by solidifying a molten metal, while applying electromagnetic vibration. In the present invention, a metal glass body with a metal glass texture structure of fine crystals nanometers to micrometers in size dispersed uniformly throughout a glass phase is manufactured by solidifying a molten metal, while applying electromagnetic vibrating force thereto. In this case, fine crystals restricted to the size range of nanometers to micrometers can be produced by adjusting the electromagnetic vibrating force conditions and the temperature conditions, and a single-phase metal glass can also be manufactured by adjusting the cooling speed. In conventional rapid solidification, a single-phase metal glass is first manufactured, and fine crystals can then be produced by heat treatment to precipitate fine crystals, but this is a complex process because a separate heat treatment step is required, while the present invention does not require such a heat treatment step.

The method of the present invention is applicable to all alloy systems capable of forming glass, and by selecting the composition of the alloy and adjusting the size of the fine crystals, it is possible to prepare a composite material that combines the unique functions of metal glass with the high strength, toughness and other properties conferred by fine crystals. That is, in the composite material of the present invention, it is possible to adjust the strength, toughness, breakage resistance and the like by selecting the composition, size and quantity of the fine crystals, while such functional properties as corrosion resistance, magnetic properties, heat resistance and the like for example can be adjusted by selecting the glass phase, and all these can be achieved in one process. The texture structure of a metal glass body obtained by the method of the present invention is defined as a metal glass texture structure of fine crystals dispersed uniformly throughout a glass phase or a texture structure of nano- or microcrystals dispersed uniformly as cells throughout a glass phase. The metal glass body of the present invention can be worked for example within the supercooled liquid range which is the stable temperature range of glass into a member of a specific shape and structure, and made into a product as a metal glass member having the same texture structure.

The present invention achieves the particular effects of (1) allowing a metal glass body to be provided having a metal glass texture structure of microcrystals dispersed uniformly throughout a glass phase, (2) allowing metal glass formation capability to be improved by the application of electromagnetic vibrating force to molten metal, (3) allowing the aforementioned metal glass body to be manufactured by a method which is not dependent on cooling speed, (4) allowing the manufacture of a lightweight, very strong metal member, (5) allowing large-size members to be produced without any restriction on the size of the resulting member, (6) expanding the range of usable metal materials by improving metal glass formation capability, (7) allowing large, bulky raw materials to be obtained because the process is resistant to the effects of cooling speed, whereas conventional methods of manufacturing metal glass cannot provide large, bulky raw materials because they are dependent on cooling speed, (8) thereby allowing metal glass, which heretofore had only been used for small products such as micromachine parts and the small parts of sensors and the like, to be used for ordinary structural materials, so that (9) the metal glass body of the present invention can be used specifically for example in the area of transportation in the chassis parts (upper arm, lower arm etc.), the springs and the like of the engine valve system and other moving parts of automobiles, and to the strut covers and other parts of airplanes, and in the area of information electronics to cases, heat sinks and the like.

### BRIEF DESCRIPTION OF THE DRAWINGS

FIG. 1 shows changes in phase occurrence due to electromagnetic vibrating force.

FIG. 2 shows changes in an XRD due to electromagnetic vibrating force.

FIG. 3 shows changes in phase occurrence due to current frequency.

FIG. 4 shows changes in phase occurrence due to electromagnetic vibration.

FIG. 5 shows the results of electromagnetic vibration to an iron alloy.

FIG. 6 shows the effects of current frequency on the thickness (4 mm dia.) of a magnesium alloy.

FIG. 7 shows the texture structures of metal glasses obtained by rapid solidification and electromagnetic vibration.

FIG. 8 shows the texture structures of metal glasses obtained by rapid solidification and electromagnetic vibration.

FIG. 9 shows the effects of electromagnetic vibration application time during the liquid stage before solidification.

FIG. 10 shows the effects of non-vibrating retention time after application of electromagnetic vibration in the liquid state.

FIG. 11 shows the effects of applied current strength of the electromagnetic vibration.

### BEST MODE FOR CARRYING OUT THE INVENTION

The present invention is explained in more detail below based on examples, but the present invention is not in any way limited by the following examples.

### EXAMPLE 1

In this invention, an electromagnetic vibration process is explained which uses Mo foil for the holding container.

1) Methods

An electromagnetic vibration-applying mechanism was prepared using Mo foil for the holding container. A Mg₆₅Y₁₀Cu₂₅ (2 mm dia., 12 mm) alloy was placed as the sample in the holding container and heated with an external heater to melt it at 550° C. for 2 minutes, and then electromagnetic vibration was applied thereto for 10 seconds, while spraying water thereon to water-cool the alloy. The effects of the electromagnetic vibrating force on metal glass formation capability were investigated.

2) Effects

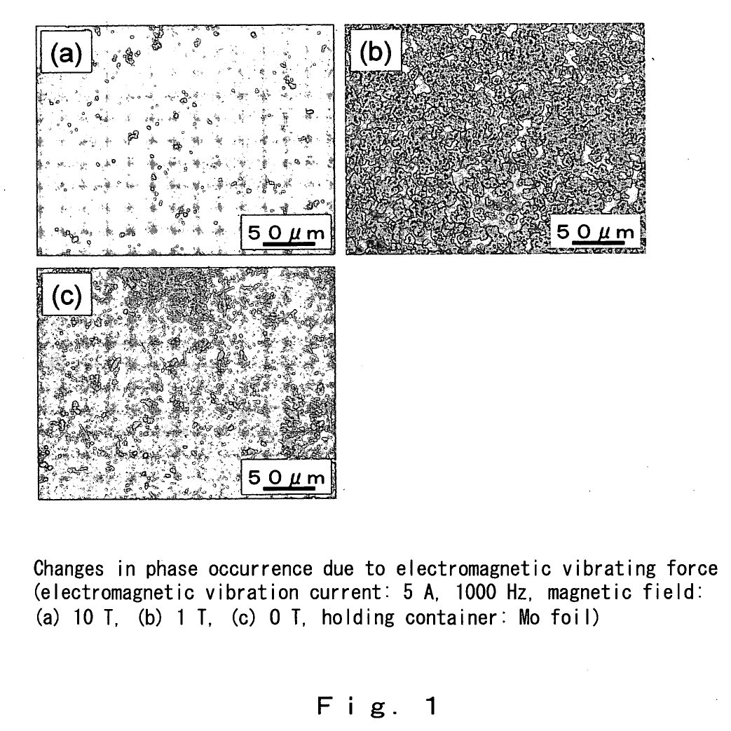

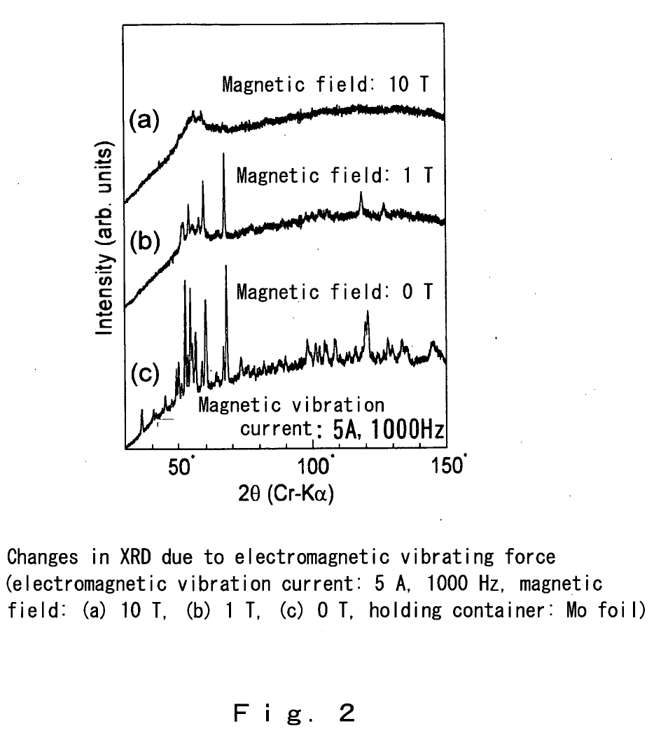

As shown in the structural photograph of FIG. 1(a) and the XRD of FIG. 2(a), when electromagnetic vibration was applied at an electromagnetic vibrating current of 5 A, 1000 Hz with a magnetic field of 10 T, a metal glass single phase was obtained.

When the electromagnetic vibrating force was weakened by reducing the magnetic field to 1 T, as shown in the structural photograph of FIG. 1(b), the metal glass phase was much reduced, and large numbers of crystal phase nuclei were observed. In the XRD of FIG. 2(b), a sharp peak from the crystal phase is seen in addition to a broad peak from the metal glass phase. When no electromagnetic vibrating force was applied, with a magnetic field of 0 T, only a bulky crystal phase was observed as shown in the structural photograph of FIG. 1(c), while only a sharp peak from the crystal phase is seen in the XRD of FIG. 2(c). This shows that electromagnetic vibrating force improves metal glass formation capability.

### EXAMPLE 2

In this example, an electromagnetic vibrating process is explained which uses an alumina tube for the holding container.

1) Methods

Using an alumina tube (external diameter 3 mm, internal diameter 2 mm) with a slower cooling speed than Mo foil as the holding container, Mg₆₅Y₁₀Cu₂₅ (2 mm dia., 12 mm) alloy was placed in the container and heated with an external heater to melt it at 550° C. for 2 minutes, and then electromagnetic vibration was applied for 10 seconds, while spraying water thereon to water-cool the alloy. The effects of electromagnetic vibrating force on metal glass formation capability using as the holding container an alumina tube, which has a slower cooling speed was investigated.

2) Effects

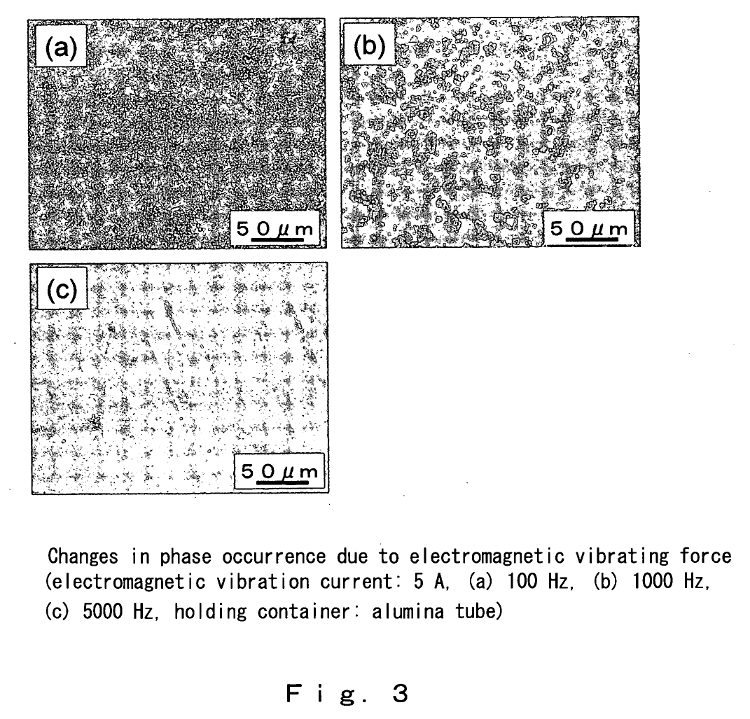

FIG. 3 shows structural photographs when the electromagnetic vibrating force was set to a magnetic field of 10 T and a magnetic vibrating current of 5 A, with the electromagnetic vibrating frequency at 100 Hz, 1000 Hz and 5000 Hz. As shown in FIG. 3(a) at an electromagnetic vibrating frequency of 100 Hz no metal glass phase was observed, only a crystal phase. As shown in FIG. 3(b), at an electromagnetic vibrating frequency of 1000 Hz large numbers of crystal phase nuclei were observed in a metal glass phase. Also, as shown in FIG. 3(c), at an electromagnetic vibrating frequency of 5000 Hz a single metal glass phase was obtained. This shows that the higher the electromagnetic vibrating frequency, the greater the improvement in metal glass formation capability.

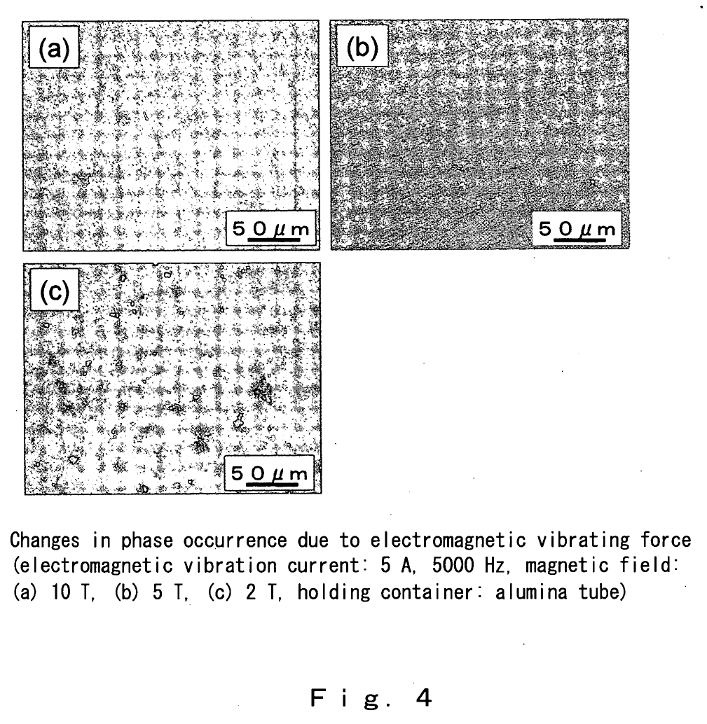

FIG. 4 shows different structural photographs with the electromagnetic vibrating force varied by changing the magnetic field to 10 T, 5 T and 2 T with the electromagnetic vibrating current set at 5 A, 5000 Hz. As shown in FIG. 4(a), with a magnetic field of 10 T a single metal glass phase was obtained, while as shown in FIG. 4(b), a single metal glass phase was still obtained when the electromagnetic vibrating force was weakened by lowering the magnetic field to 5 T, but when the electromagnetic vibrating force was weakened still further by lowering the magnetic field to 2 T, the metal glass phase was greatly reduced while many crystal phase nuclei were seen as shown in the structural photograph of FIG. 4(c), indicating the appearance of a crystal phase. This also shows that electromagnetic vibrating force improves metal glass formation capability.

### EXAMPLE 3

In this example, the effects were studied in an alloy system other than Mg.

1) Methods

To confirm that this process is effective even with metal materials other than Mg₆₅Y₁₀Cu₂₅ alloy, a similar test was performed using (Fe_{0.6}Co_{0.4})₇₂Si₄B₂₀Nb₄ alloy, the melting point of which is about 800° C. higher than that of Mg alloy, and the effects of this process were confirmed. The current frequency range was 10 Hz or more, the magnetic field strength range was 1 Tesla or more, and the current strength range was 1×10⁶ A/m² or more.

2) Results

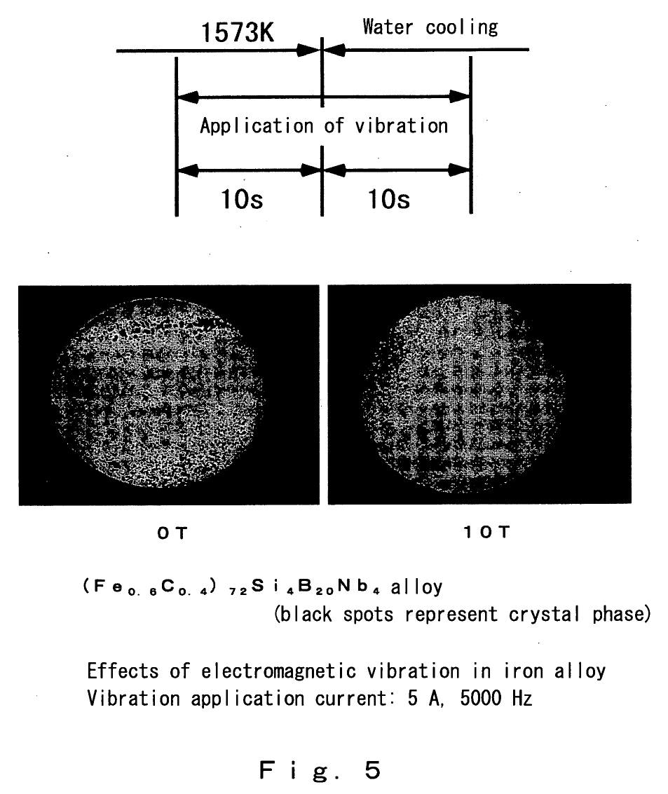

The results are shown in FIG. 5. When no electromagnetic vibration was applied, many crystals were generated which could be distinguished by their black color, but when electromagnetic vibration was applied (5 A, 5,000 Hz, 10 T), the crystals were reduced and there was more vitrification. This shows that generation of metal glass by an electromagnetic vibration process is effective even in metal materials other than magnesium alloys.

### EXAMPLE 4

In this example, improvement of metal glass formation capability by an increase in current frequency was investigated in an Mg alloy.

1) Methods

The effects of current frequency (5,000 Hz, 50,000 Hz) on ease of vitrification of Mg₆₅Y₁₀Cu₂₅ alloy by means of electromagnetic vibration (20 A, 10 T) were investigated.

2) Results

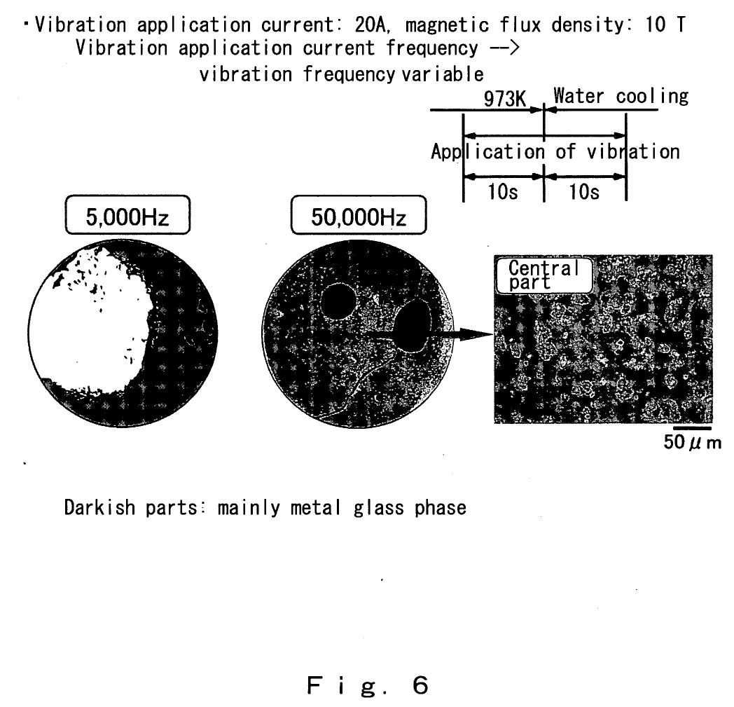

Because a 4 mm dia. sample has twice the diameter of a 2 mm dia. sample, it has a slower cooling speed and is consequently harder to vitrify. However, as shown in FIG. 6, vitrification can be easily achieved even in such cases by increasing the current frequency in a process using electromagnetic vibrating force. This shows that in a method of producing metal glass by an electromagnetic vibration process, the electromagnetic vibration force and the electromagnetic vibration frequency can be used to compensate for the effects of cooling speed.

### EXAMPLE 5

In this example, the texture structure was compared with that of a rapid-solidified material.

1) Methods

The structures of both glasses were analyzed by high-resolution FE-TEM (field emission transmission electron microscopy), and the lattice images were also checked.

2) Results

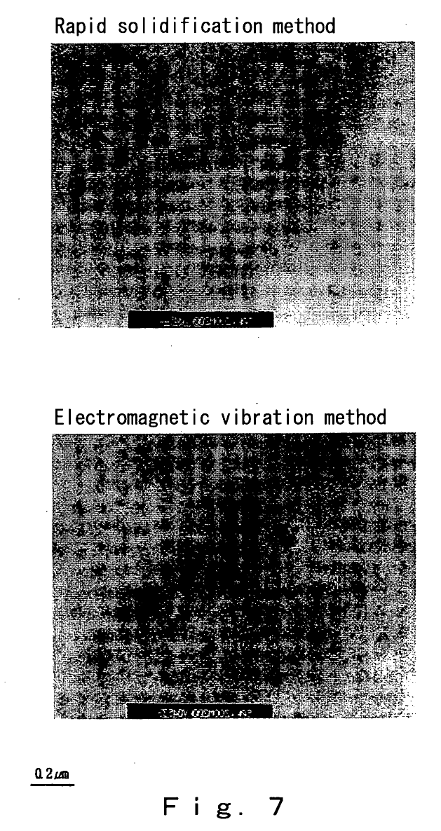

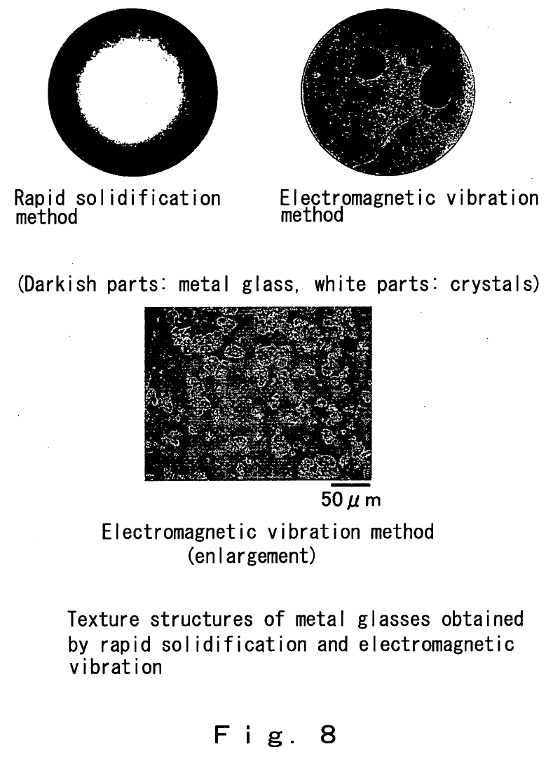

Differences were found between the two as a result. The difference between the texture structure of metal glass produced by conventional rapid solidification and the texture structure of a metal glass produced by the process of the present invention is that the former consists of a single glass phase while the latter is a metal glass texture structure having fine crystals dispersed uniformly throughout the glass phase. A metal glass body produced by the process of the present invention can be confirmed by looking at this structure, and a metal glass body of the present invention can be easily distinguished in this way from a metal glass produced by conventional rapid cooling. That is, a metal glass body obtained by the process of the present invention is characterized by having a metal glass structure with uniformly dispersed fine crystals. FIG. 7 shows the texture structure of a metal glass body in which fine crystals are uniformly dispersed as cells throughout a glass phase. FIG. 8 shows one example of a metal glass body having uniformly dispersed fine crystals micrometers in size.

### EXAMPLE 6

In this example the effects of electromagnetic vibration application time at the liquid stage before solidification were investigated.

1) Methods

The effects of application time of electromagnetic vibration (5 A, 5000 Hz, 10 T) at the molten stage at a heating level of about 100° C. before water-cooling to initiate solidification were investigated with respect to ease of vitrification of Mg₆₅Y₁₀Cu₂₅ alloy.

2) Results

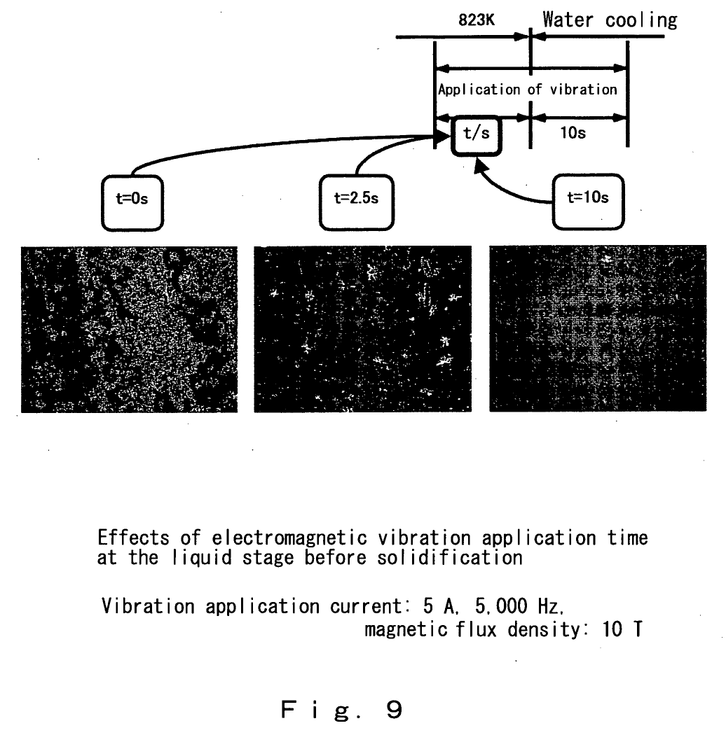

As shown in FIG. 9, when the electromagnetic vibration application time before water cooling was 0 seconds, subsequent cooling resulted in almost complete crystallization. When the electromagnetic vibration application time was 2.5 seconds, crystals were produced but in very small quantities. When the electromagnetic vibration application time was 10 seconds there was no crystallization, and only metal glass was produced. This shows that increasing the electromagnetic vibration application time at the liquid stage before solidification improves metal glass formation capability.

### EXAMPLE 7

In this example, the effects of non-vibrating retention time at the liquid stage after application of electromagnetic vibration were investigated.

1) Methods

Electromagnetic vibration (5 A, 5000 Hz, 10 T) was applied for 10 seconds at the molten stage at a heating level of about 100° C., and the effects of the subsequent rest time without electromagnetic vibration before water cooling to initiate solidification were investigated with respect to ease of vitrification of Mg₆₅Y₁₀Cu₂₅ alloy.

2) Results

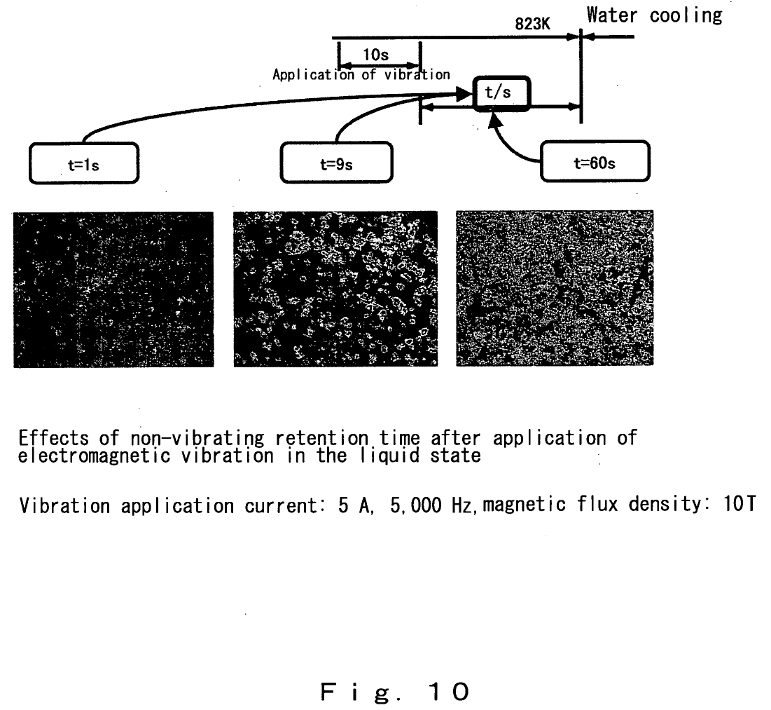

As shown in FIG. 10, when the rest time was 1 second some crystallization occurred with subsequent water cooling. When the rest time was 9 seconds, there was considerably more crystal production during water cooling. When the rest time was 60 seconds, there was almost complete crystallization during water cooling. This shows that the longer the non-vibrating retention time following application of electromagnetic vibration at the liquid stage, the lower the metal glass formation capability.

### EXAMPLE 8

In this example, the effects of the applied current strength of the electromagnetic vibration were investigated.

1) Methods

Electromagnetic vibration (0-10 A, 5000 Hz, 10 T) was applied for 10 seconds at the molten stage at a heating level of about 100° C., solidification was then initiated by water cooling, and the electromagnetic vibration (0-10 A, 5000 Hz, 10 T) was then interrupted for 10 seconds and the effects of electromagnetic vibrating force at different current levels were investigated with respect to ease of vitrification of Mg₆₅Y₁₀Cu₂₅ alloy.

2) Results

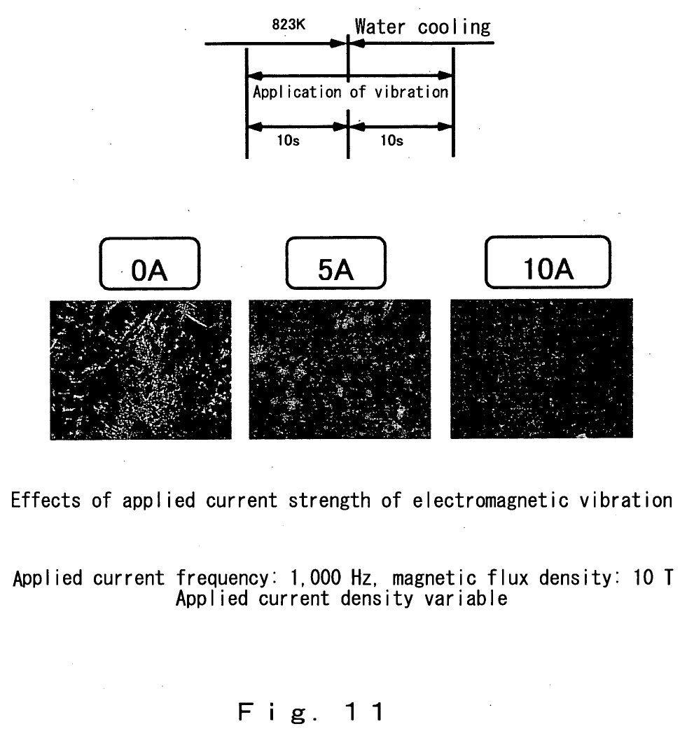

As shown in FIG. 11, it was shown that increasing the electromagnetic vibrating force by increasing the current strength resulting in greater metal glass formation capability.

### INDUSTRIAL APPLICABILITY

As explained in detail above, the present invention relates to a metal glass body and to a manufacturing method and apparatus therefor, and the present invention allows a novel metal glass body to be provided having a metal glass texture structure of fine crystals uniformly dispersed throughout a glass phase. Because conventional methods of manufacturing metal glass have relied on rapid cooling speeds they have not been able to provide large, bulky raw materials, but large, bulky raw materials can be obtained with this process because it is resistant to the effects of cooling speed. The metal glass body of the present invention can be used for example in ultraprecise members and precision machine parts for micromachines and in the functional members of such high-precision instruments as Coriolis flow meters, pressure sensors, linear actuators and the like, and it can be used as a light and strong structural material for airplanes, automobiles and the like. The present invention is useful in that it improves metal glass formation capability by means of electromagnetic vibration, thereby providing a mass-production technology for metal glass products which holds promise for light and strong highly-functional structural members and highly functional members.

1. A metal glass body prepared by a method that does not depend on cooling speed, characterized in that the metal glass body has a metal glass texture structure of fine crystals uniformly dispersed throughout a glass phase.

2. The metal glass body according to claim 1, wherein the fine crystals have a size controlled in the range of nanometers to micrometers.

3. The metal glass body according to claim 1, wherein the metal is an alloy system capable of forming glass.

4. The metal glass body according to claim 1, wherein the metal glass body is a composite material comprising fine crystals of a specific composition and a metal glass single phase.

5. The metal glass body according to claim 4, wherein the composition of the fine crystals is controlled by selecting the alloy composition.

6. A metal glass product comprising the metal glass body according to any of claims 1 through 5.

7. The metal glass product according to claim 6, wherein the product is a highly-functional member.

8. The metal glass product according to claim 6, wherein the product is a structural member.

9. A method for producing a metal glass body, comprising solidifying a molten metal while applying electromagnetic vibrating force thereto, and thereby producing a single-phase metal glass or a metal glass body having a metal glass texture structure of fine crystals uniformly dispersed throughout a glass phase.

10. The method according to claim 9, wherein a direct current magnetic field and an alternating current electrical field are simultaneously applied for applying electromagnetic vibration on the molten metal to produce the metal glass body.

11. The method according to claim 9, wherein the metal glass body is produced with generation of electromagnetic vibration in a specific current frequency band (100 Hz or more).

12. The method according to claim 9, wherein the metal glass body is produced with generation of electromagnetic vibration at a specific magnetic field strength (1 Tesla or more).

13. The method according to claim 9, wherein metal glass formation capability is improved by increasing the current frequency.

14. The method according to claim 9, wherein metal glass formation capability is improved by applying the electromagnetic vibration at the liquid stage before solidification.

15. The method according to claim 14, wherein the non-vibrating retention time after application of electromagnetic vibration is shortened.

16. The method according to claim 9, wherein metal glass formation capability is improved by increasing the applied current strength of the electromagnetic vibration.

17. The method according to claim 9, wherein the metal is an alloy system capable of forming glass.

18. The method according to claim 17, wherein the alloy composition is selected and the electromagnetic vibrating force conditions and/or temperature conditions are adjusted so as to produce a composite material in which the functionality of the metal glass and the properties of strength, toughness and/or resistance to breakage conferred by the fine crystals are controlled.

19. An apparatus for producing a metal glass body characterized in that the apparatus is equipped with a container for storing a sample metal material, means for heating and melting the metal material, means for generating and applying electromagnetic vibration, cooling means for cooling a molten metal and means for measuring and controlling temperature, wherein a metal glass is produced by solidifying the molten metal while applying electromagnetic vibrating force thereto.

20. The apparatus according to claim 19, wherein the electromagnetic vibration generating means is a superconducting magnet.
